(19) United States
(12) Patent Application Publication
(10) Pub. No.: US 2005/0160794 A1
(43) Pub. Date: Jul. 28, 2005

(54) Apparatus and method for container leakage testing

(76) Inventors: Donald W. Sonntag, Carl Junction, MO (US); Jeffrey Schultz, Web City, MO (US)

Correspondence Address: TIMOTHY J MARTIN, PC, 9250 W 5TH AVENUE, SUITE 200, LAKEWOOD, CO, 80226, US

(21) Appl. No.: 10/765,270

(22) Filed: Jan. 26, 2004

(51) Int. Cl. G01M 3/04

(52) U.S. Cl. 73/40; 73/327

(57) ABSTRACT

Apparatus and method for container leak detection employs a tank of liquid and a conveyor assembly with a drive therefor to convey containers through the tank beneath the surface of the liquid. A light source illuminates the liquid in an observation region. At least on optical detector has a view line across the tank to monitor for bubbles of a selected size. A contrasting background may be used to enhance detection, and magnetic devices may be used to hold the containers on the advance portion of the conveyor. The optical detector in the exemplary embodiments is a imaging processor. Access doors are provided to permit removal of leaking container upon its detection. The system may be automated with controls to stop the conveyor upon detection of a leaking container and to generate an alarm. The method involves the steps performed by this apparatus.

### FIELD OF THE INVENTION

The present invention generally relates to automated container-assembling equipment. More particularly, the present invention concerns liquid submersion tanks which containers of product or other articles may be submerged and monitored for leakage evidenced by bubbles emanating therefrom. The present invention specifically concerns and apparatus and method for the optical monitoring for the presence of bubbles in submerged container leak detection apparatus.

### BACKGROUND OF THE INVENTION

A wide variety of articles are manufactured which are intended to be relatively airtight. Such articles include, for example, packaging containers for aerosol products, volatile compounds, hazardous materials and the like. In addition, articles intended to be airtight may also be products such as fuel tanks, radiators, fuel system components, water pumps, refrigeration components and a host of others are desired to have some degree of “leak tightness”.

One technique to test for leak tightness in such varied articles, including packaging containers, is known as emersion testing. In emersion testing, a liquid bath is provided, and the article to be tested is submerged beneath the surface of the liquid. In the case of pressurized containers, the pressure differential between the inside of the container and the liquid results in the escape of gas from any leak which results in bubbles in the liquid. The presence of bubbles is visually monitored, typically by an operator, so that a leaking container may be detected. In some instances, in liquid emersion testing, the component may be pressurized with gas and then immersed within the liquid medium.

Typically, the liquid used for such emersion baths is water. In the case of pressurized articles such as aerosol containers, the liquid present in the liquid bath may be maintained at an ambient temperature. However, in some instances it is necessary to increase the pressure in the articles. One such example is a container of a volatile compound. In these instances, it is known to heat the liquid in the liquid bath to an elevated temperature. Placing the articles/containers within the heated liquid bath raises the temperature of contents within their interiors thereby to increase the pressure which may result in gas leakage that can be detected, again, through bubbles in the liquid.

In liquid emersion testing, the location of bubbles indicates the location of the leak in the container or component, and the frequency and size of the bubbles can be used to estimate the leakage rate. Liquid emersion testing has several advantages which include low equipment cost relative to other methods, location of the leak can be determined, the equipment can easily be made durable enough for industrial applications, and various size and shaped components/containers can be tested utilizing one test apparatus.

Where emersion testing is used for aerosol containers, it is known to employ a tank which holds the emersion liquid, e.g., water. Often, the water is maintained at a temperature of approximately 120 degrees/140 degrees F. A conveyor carries pucks that receive the containers during transport from one end of the emersion tank to the other. During the advancement of the cans through the tank, the conveyor submerges the containers beneath the surface of the liquid so that an inspecting operator may visually observe the containers at an observation point to determine whether bubbles are present. If a container is leaking, the operator can stop the conveyor and move the offending container.

Existing emersion testing systems that utilizes a human observer, however, have the disadvantage of relying upon the human operator for visual monitoring the presence of bubbles. Even though an operator may have the best intentions, an operator may become distracted by surrounding activities thus reducing the attention given to the containers that are being tested. Likewise, over a period of time, an operator may become bored and less observant of the containers to be tested. In addition, throughout a regular work shift, an operator may become increasingly fatigued, and such fatigue may impact on the operator's attention to the leak detection procedure.

In an effort to reduce the potential of operator error, it is known to employ an automated leak detection process. For example, it is known to detect to presence of a bubble in a liquid by directing a beam of light through a portion of the liquid so as to be incident on a photo detector. This creates a known electrical signal from the photo detector based upon the intensity of the light. Should a bubble pass through the light beam, the intensity of the light incident on the photo detector becomes changed due to the reflection and/or refraction of the bubble such that a change in the signal from the photo detector indicates the presence of a bubble.

This technique, however, is dependent upon both the size and the location of the bubbles. If the component to be tested is stationary, typically a stream of bubbles will rise along a common path making them more susceptible to the photo detection. However, where components or containers are moved by a conveyor or other transport through the emersion bath, the path and location of the bubbles may be varied making photo detection more difficult. Also, such photo detection systems rely upon bubbles or significant size to interfere with the beam of light from the light source such that the sensitivity of such systems is limited.

In one effort to resolve some of these issues with photo detector systems, a bubble detection system was developed as described in U.S. Pat. No. 5,263,361 (and its parent patents) issued Nov. 23, 1993 to Gates. Here, a channeling device is shown to channel bubbles so as to provide complete coverage of the surface area of the component to be tested. The channeling device directs bubbles along a predetermined path about which the light source of the photocell may be placed.

Despite the existence of emersion testers and despite the efforts to develop automated bubble detection for leakage, there remains a need for improved apparatus and methods of detecting leakage from components/containers. There is a need for leak testing apparatus and methods which can monitor for the presence of leakage in a dynamic operation wherein containers/components continuously move through a submersion bath. There is further need for such automated equipment which can function at a high degree of sensitivity and can reduce the effect of operator error.

### SUMMARY OF THE INVENTION

It is an object of the present invention to provide a new and useful apparatus and method for detecting a leak condition in an article.

It is further object of the present invention to provide an apparatus and method that may be used in an automated production line to monitor for leakage in articles such as containers.

A further object of the present invention is to provide an apparatus and method that reduces insensitivities inherent in existing light source/photo cell detection systems.

Still a further object of the present invention is to provide an apparatus and method which can be adjusted to monitor for leakage of different magnitude.

According to the present invention, then, an apparatus and a method is described for detecting leakage from a faulty article alone or that is a member of an ensemble of articles. Broadly, the apparatus includes a tank that has an interior adapted to hold a liquid bath with the tank including an observation region. When the tank is in a filled state, the liquid bath thus has an upper surface. A conveyor assembly is provided and includes an advance portion operative to move in a longitudinal direction from an upstream location above the upper surface of the liquid to a downstream location above the upper surface of the liquid through an intermediate location below the liquid surface at a depth such that a container supported on the conveyor assembly is submerged beneath the upper surface of the liquid bath as it moves pass the observation region. A drive is provided and is operative to advance the advance portion from the upstream location to the downstream location. The apparatus further includes a light source operative to illuminate liquid located in the observation region when the tank is in the filled state, and at least one optical detector is disposed at the observation station. The optical detector is operative to monitor a monitored volume of liquid in the view field that has a horizontal view width and a vertical view height and that has a transverse view depth of field along the view line that extends substantially across the tank in a direction that is transverse to the longitudinal direction in the observation region. The optical detector is operative to generate a leak signal indicating the presence of bubbles of a selected bubble size in the monitored volume of liquid caused by gas escaping from a faulty container. In the exemplary embodiments, the optical detector further is disclosed to be an imaging processor.

In the exemplary embodiment, the tank is elongated and includes an elongated bottom wall, an upstream end wall, a downstream end wall and first and second elongated sidewalls in spaced apart, opposed relation to one another. The sidewalls extend between the upstream and downstream end walls to define the interior of the tank, and the observation station is then formed to include a substantially transparent panel in the first elongated sidewall. The observation region can further include a background associated with a second elongated sidewall with this background being in opposed relation to the transparent panel. The background includes a light absorbing material. Here, the background may be formed of a black background material, such as a light-absorbing panel. The light-absorbing panel may be removably supported relative to the second elongated sidewall. To this end, a pair of spaced apart opposed channel pieces may be mounted on the second elongated sidewall thereby to define a slide way. The light-absorbing panel is then sized and adapted to be slideably received therein.

The conveyor assembly, in the exemplary embodiment, is an endless conveyor belt having an advance portion and a return portion extending between an upstream conveyor terminus and a downstream conveyor terminus. Thus, the advance portion of the conveyor assembly has a container support side adapted to support containers thereon. The return portion of the conveyor assembly can be located externally of the tank, and the upstream terminus and the downstream terminus can each be located exteriorly of the tank. The conveyor belt may be constructed of stainless steel. Further, a magnetic hold mount assembly can be disposed proximately to the advanced portion of the container on a side thereof that is opposite the support side. The magnetic hold down assembly is operative to magnetically retain submerged ones of the containers on the advanced portion. The magnetic hold down assembly can include at least one elongated bar magnet extending longitudinally of the tank.

The light source is disclosed to be supported above the observation region and may be a fluorescent light source. The light source may be mounted by a light hood that is disclosed proximately to the observation region and is operative to mask at least some ambient light against entering the observation region. This light hood can include a housing extending longitudinally of and above the tank. Moreover, the housing may include at least one door opening and a door moveable between an open position allowing access to the advanced portion of the conveyor assembly in the observation region and a closed position.

The apparatus can also include a blow off assembly disposed proximately to the conveyor assembly at a downstream location. The blow off assembly is operative to produce airflow whereby at least some of the liquid residing on the containers after the containers are removed from the submerged state is removed by the airflow.

Various electronic controls are also discussed in this application. These electronic controls can be operative in response to the leak signal generated by the optical detector to disable the conveyor assembly thereby to stop advancement of the advanced portion. These electronic controls may also be used to generate an alarm indicating detection of a faulty container.

Moreover, the optical detector is disclosed to be one wherein the longitudinal view width of a vertical view height of the view field is selectively variable, but, in any event, the optical detector may be adjustable whereby the selected bubble size to be detected is selectively variable. Moreover, the apparatus may optionally include at least two optical detectors disposed at the observation station. Each of these optical detectors is inoperative to monitor the monitored volume of liquid. Each of the optical detectors have different transverse view lines, and each is operative to generate a leak signal indicating the presence of bubbles of a selected bubble size in the monitored volume of liquid caused by gas escaping from the faulty container.

The method according to the present invention contemplates any of the processing steps that are inherent in the above-described apparatus. More particularly, the present invention contemplates a method of detecting a leak in an article. Here, the method includes a first step of providing a liquid bath having an upper liquid surface. Next, an article to be tested is placed at an observation region wherein the article is submerged beneath the upper surface of the liquid bath. The method includes the step of illuminating the observation region and monitoring the observation region by means of at least one imaging processor in order to detect bubbles of a threshold size emanating from a faulty article. Finally, the method includes the generation of a control signal in response to the presence of a bubble having a size equal to or greater than the threshold size. This method can also include the step of heating the liquid bath thereby to pressurize the article or to increase the pressure in an already pressurized article. The step of placing the article at an observation region can be accomplished by statically placing the article at the observation region or, alternatively, dynamically advancing the article passed the observation region. Where the article is advanced dynamically passed the observation region, the method can include the step of disabling the advancement of the article in response to the control signal.

Moreover, wherein the step of advancing the article pass the observation region is dynamic, the method can include the step of supporting the article on an endless conveyor belt. This endless conveyor belt, again, can have an upstream terminus and a downstream terminus each located exteriorly of the liquid bath. Here again, the method may include the step of magnetically retaining the article on the conveyor belt while the article is submerged.

Further, according to the method of the present invention, it is contemplated that the threshold size of the bubbles to be detected is selectively variable. The method may include the step of blowing liquid off of the article at a downstream location after the article has exited the liquid bath. Finally, the method may also include the step of monitoring the observation the region by means of at least two imaging processors in order to detect bubbles of a thresh hold size imitating from a faulty article.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view of an emersion testing apparatus according to the exemplary embodiment of the present invention;

FIG. 2 is a side view in elevation, partially broken away showing the emersion testing apparatus of FIG. 1;

FIG. 3 is a top plan view of the emersion testing apparatus of FIGS. 1 and 2;

FIG. 4 is a cross-sectional view taken about lines 4-4 of FIG. 2;

FIG. 5 is a cross-sectional view taken about lines 5-5 of FIG. 4;

FIG. 6 is a side view in elevation showing a transition section of the advanced portion of the conveyor used with the exemplary embodiment of the present invention;

FIG. 7 is a rear view in elevation showing the mounting bracket for the digital imaging device used with the exemplary embodiment of the present invention; and

FIG. 8 is a top view in cross-section, similar to FIG. 5, showing an alternative embodiment of the present invention.

### DETAILED DESCRIPTION OF THE EXEMPLARY EMBODIMENTS

The present invention broadly concerns apparatus and methods adapted to detect leakage from a faulty article. The techniques described herein could be used both in static systems and in dynamic systems. By the phrase “static system”, what is meant is a system wherein an article may be placed in a test chamber and held stationary during the testing operation. By “dynamic system”, it is meant that an article may move either continuously or intermittently (in incremental steps) through a test chamber.

The present invention is particularly described with respect to testing of containers, such as aerosol cans or cans containing material that can be placed in a pressurized state (such as by heating) in order to observe whether or not the container will leak. However, it should be understood that the apparatus and methods described herein may be employed with numerous different types of articles wherein those articles are either pressurized or can be placed in a pressurized condition. Therefore, in describing the apparatus and methods as set forth below, it is no way intended to limit this application to containers or cans.

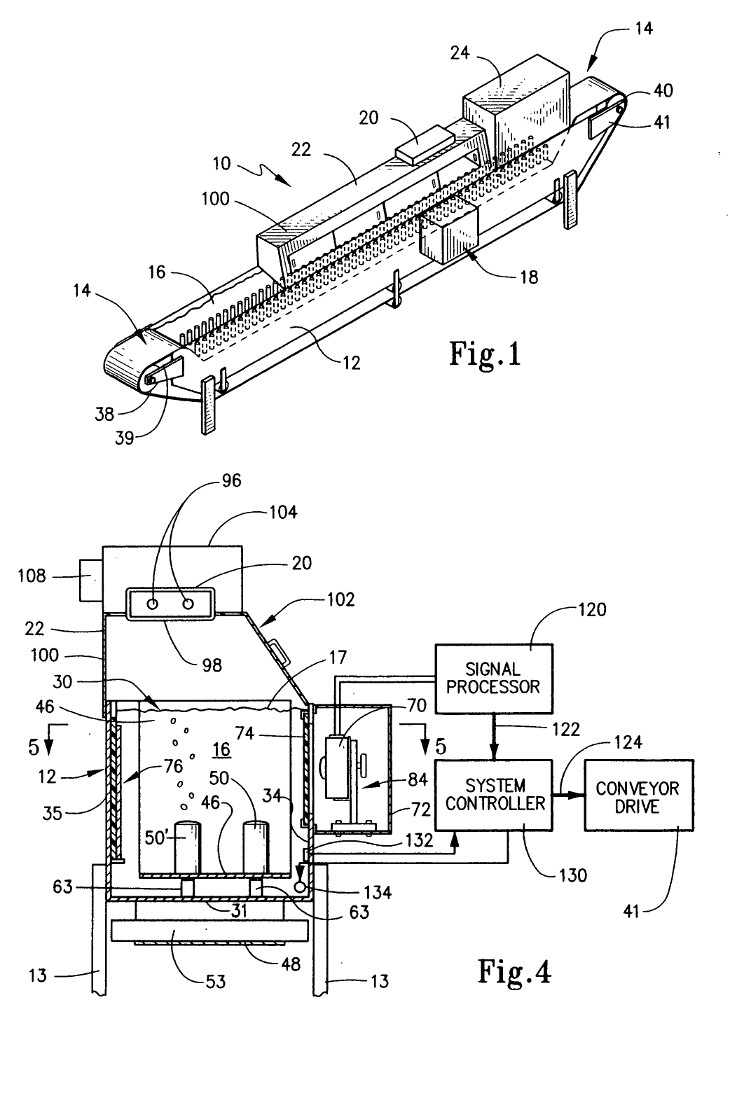

With that in mind, a first exemplary embodiment of the present invention is introduced in FIG. 1. In FIG. 1, test apparatus 10 includes a tank 12 and a conveyor assembly 14 that is operative to advance containers through a liquid bath 16. An observation region 18 is provided, and a light source 20 is used to illuminate containers in the observation region 18. A light hood 22 is provided to shield the containers at the observation from ambient light, and a blow off hood 24 is provided to create airflow to remove unwanted liquid from the containers as they exit test apparatus 10.

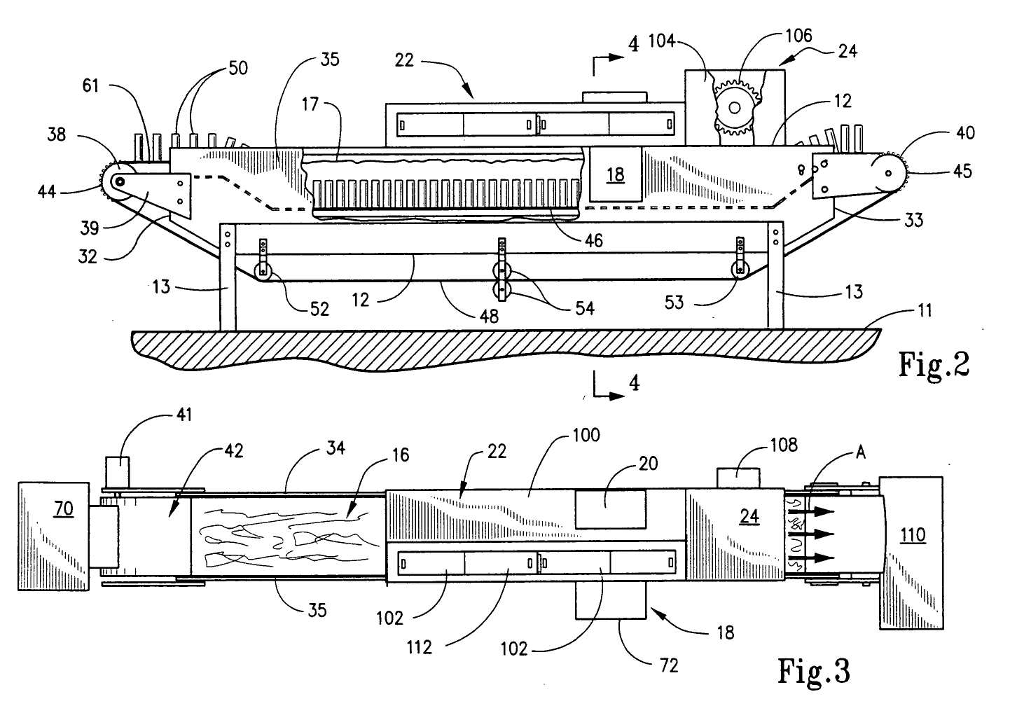

From the foregoing brief identification of elements, it should be appreciated that test apparatus 10 is a dynamic apparatus wherein containers move throught the observation region 18 where they are monitored to detect a faulty (i.e. leaking, container). The structure of test apparatus 10 may be more fully appreciated with reference to FIGS. 2-5. In these figures, it may be seen that tank 12 is elongated and includes an elongated bottom wall 31 an upstream end wall 32, a downstream end wall 33 and first and second elongated sidewalls 34 and 35. First and second elongated sidewalls 34 and 35 are in spaced-apart, opposed relation to one another and extend between the upstream and downstream end walls 32 and 33 to define an interior 30 for tank 12. Interior 30 is adapted to hold a liquid bath 16 when the tank is in a filled state, with liquid bath 16 having an upper surface 17.

Conveyor assembly 14 includes, for example, an upstream roller 38 that is supported by means of a pair of bracket arms 39 that are mounted to tank 12. Likewise, conveyor assembly 14 includes a downstream roller 40 that is rotatably journaled between a pair of bracket arms 41. Rollers 38 and 40 moveably support an endless conveyor belt 42 between an upstream terminus 44 and a downstream terminus 45. Accordingly, as is best shown in FIG. 4, conveyor belt 42 includes an advance portion 46 and a return portion 48. Advance portion 46 thus moves in a longitudinal direction relative to tank 12 from an upstream location to a downstream location.

As is seen in reference to FIGS. 1-4, the advance portion 46 of belt 42 is located above the upper surface 17 of liquid bath 16 at both the upstream and downstream location. However, advance portion 46 of belt 42 moves through an intermediate location between termini 44 and 45 wherein advance portion 46 is located below the liquid surface 17. Moreover, this depth should be sufficient so that an article, such as containers 50 placed thereon are submerged in a submerged state wherein they are beneath the upper surface 17 of liquid bath 16, specifically, as those containers 50 move pass the observation region 18 when the tank is in the filled state. Conveyor belt 42 may conveniently be constructed of stainless steel or other materials known in the art, and it may be noted that each of upstream terminus 44 and downstream terminus 45 are located exteriorly of tank 12.

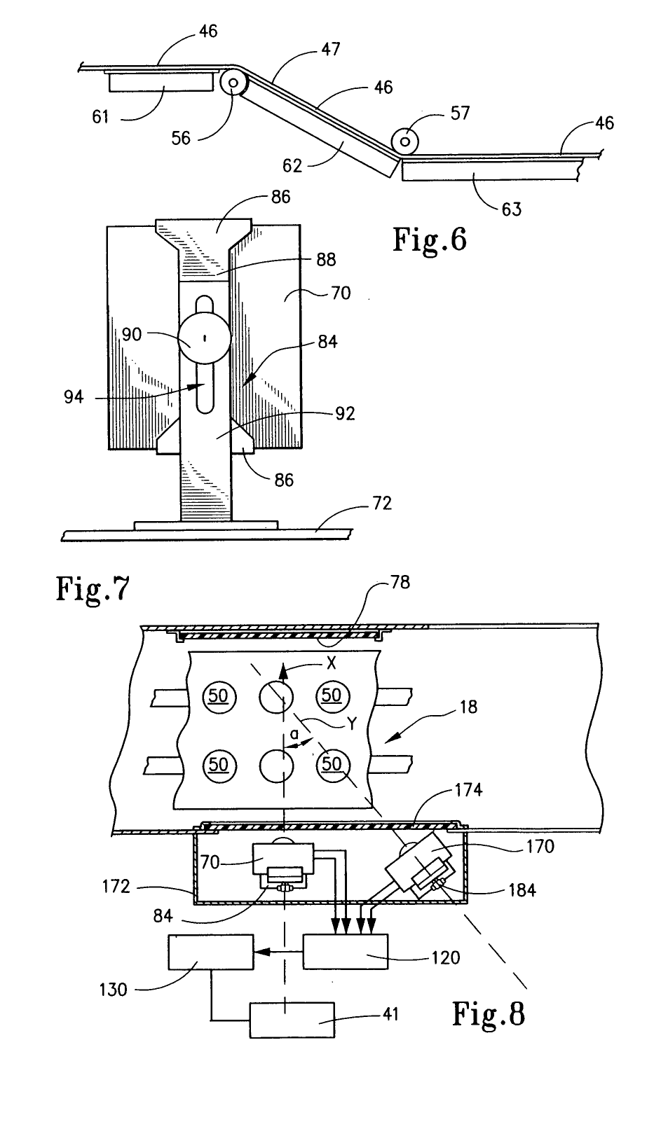

While it is certainly possible to construct conveyor assembly 14 so that return portion 48 is located interiorly of tank 12, in the embodiment shown in FIGS. 1-4, return portion 48 is located exteriorly of and beneath tank 12. To this end, an upstream guide roller 52 and a downstream guide roller 53 support return portion 48 of conveyor belt 42 for longitudinal movement from the downstream location to the upstream location. Intermediate guide rollers 54 also support return portion 48 medially of tank 12. To this end, also, tank 12 is positioned above a support surface 11 by means of a plurality of legs 13 that support tank 12, as is shown in FIG. 2. In order to conform advance portion 46 so that it moves from a position above upper surface 27 of liquid bath 26 to a submerged state, bending rollers 56 and 57 are employed at the upstream and downstream regions of tank 12. A pair of such bending rollers, 56, 57 are illustrated in FIG. 6, and it should be here understood the bending roller 57 may not extend completely across advance portion 46 of conveyor belt 42 for, if it did, it would interfere in the transport of containers placed on the support side or upper surface 47 of advance portion 46.

Further, in order to retain containers on advance portion 46 of conveyor belt 42, a magnetic hold down assembly is provided that is disposed proximately to the advance portion 46 on a side thereof that is opposite the support side 47. The magnetic hold down assembly is operative to magnetically retain submerged ones of the containers on the advance portion, as is known in the art. More particularly, the magnetic hold down assembly includes at least one, but preferably a plurality of elongated bar magnets, such as magnets 61, 62 and 63. Containers 50 may be then introduced at the upstream location, for example, by means of any suitable loading apparatus 70 illustrated in FIG. 3 of any type known in the art. Loader 70 does not form part of the present invention, so the details of that assembly are not described herein. In any event, as is illustrated in several of the figures, containers 50 form two spaced-apart rows that are then advanced through the liquid bath 16. Bar magnets 61, 62 and 63 retain containers 50 on the advance portion 14 as they move from an elevated position at the upstream location, to a submerged condition at an intermediate location and once again to an elevated condition at the downstream location.

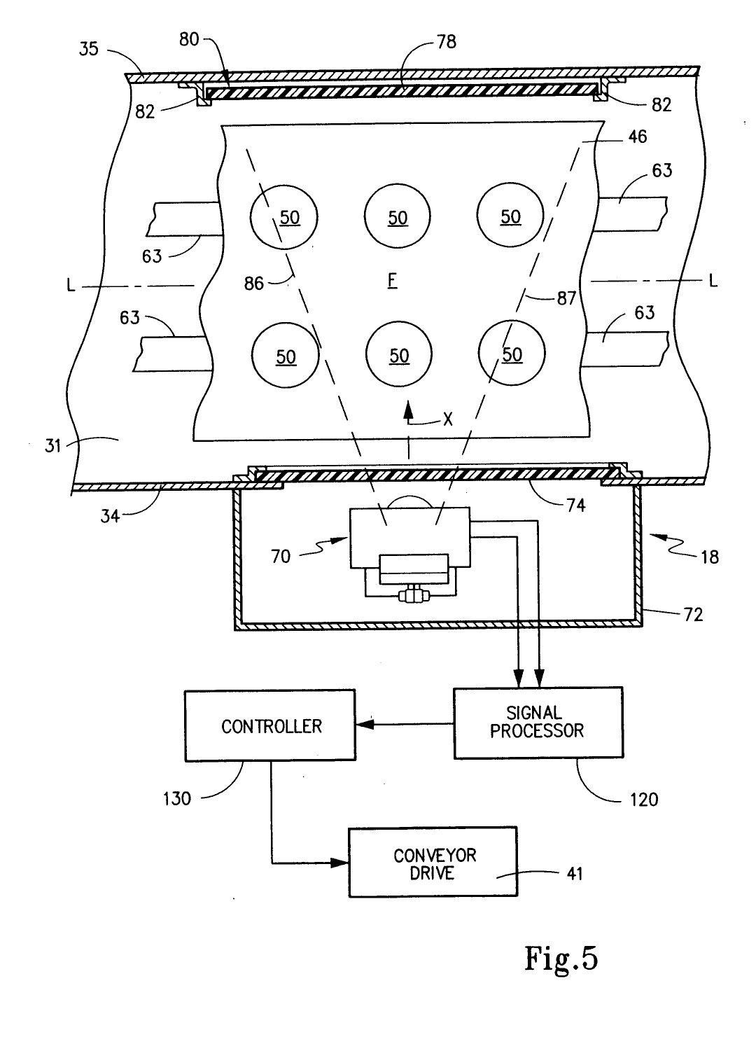

As noted above, containers 50 are dynamically moved passed an observation region 18 wherein the containers 50 are monitored for leakage. Observation region 18 is best illustrated in FIGS. 4 and 5 and the components thereof define an observation station. Here, it may be seen that an optical detector in the form of an imaging processor 70 is disposed in a housing 72 on a lateral side of tank 12. First sidewall 34 includes a substantially transparent panel 74 suitably mounted and sealed so as to provide a window into the interior of tank 12. A background 76 is in an opposed facing relation to transparent panel 74 with background 76 being associated with second sidewall 35. As is shown in FIG. 5, background 76 may include a light-absorbing panel 78 that is slideably received in a slideway 80 formed by a pair of channel brackets 82. It is contemplated that the background is a black background defined by light absorbing panel 78 with panel 78 being removably supported relative to the second elongated sidewall 35.

From the foregoing, it should be understood that imaging processor 70 may be supported by means of a support assembly 84, illustrated in FIG. 7. Imaging processor 70 may conveniently be DVT smart image sensor such as that identified as the Legend 530 manufactured by DVT Corporation of Norcross, Ga. As is known, such imaging processors are vision systems that can, within their pixel resolution, count, measure, find features, compare patterns, and the like. Such vision sensors can be adjusted so as to control their resolution to register objects or images of a certain size appearing within their vision field while ignoring objects of a lesser size. Typically the field of vision can be selectively controlled by the user.

Support assembly 84, in the present invention, mounts imaging processor 70 so that it has a view line indicated by arrow “X” and a view field “F” between dashed lines 86 and 87 that has a horizontal view width and a vertical view height and a transverse view depth of field along view line “X” that extends substantially across tank 12 in a direction that is transverse to the longitudinal direction, with this view field being in the observation region 18. By “transverse” it is meant that the view line is in any cross-wise direction that may be perpendicular to or at an angle to the longitudinal direction “L” shown in FIG. 5. Accordingly, “transverse” does not mean merely perpendicular.

Imaging processor 70 is further operative to generate a signal indicating the presence of an object, such as bubbles, of a selected size, such as a selected bubble size, in the monitored volume of liquid where such bubbles are caused by gas escaping from a faulty article such as faulty container 50′ shown in FIG. 4. Support assembly 84 mounts imaging processor 70 between a pair of jaws 86 that are on a bracket 88 that is connected by screw clamp 90 to a bracket 92 having a slot 94 so that the height of imaging processor 70 may be conveniently adjusted.

As noted above, a light source is provided that is operative to illuminate liquid located in the observation region when the tank 12 is in a filled state. As is shown in FIGS. 1 and 4, light source 20 is mounted to a light hood 22 and may include lights 96 in the form of fluorescent tubes which emit light that may exit transparent panel 98 so as to be incident on containers 50 located in the observation region 18. It should be appreciated that any suitable light source 20 is within the scope of this invention. However, it is desirable that light source 20 be supported above the observation region, although such placement is not absolute required. Further, light source 20 is supported by a light hood 22 that is disposed proximately to the observation region 18 is operative to mask at least some ambient light against entering the observation region 18.

Light hood 22 includes an elongated housing 100 that includes at least one door, but preferably a plurality of doors such as doors 102. Such doors are moveable between an open position allowing access to the advance portion of the conveyor assembly in the observation region and a closed position shutting off access to the advanced portion. Housing 100 thus extends longitudinally of and above tank 12.

Also as noted above, the test apparatus 10 may optionally include a blow off assembly 24 that include a blow off hood 104 that houses a fan 106 driven by a motor 108 thereby to produce an airflow “A” at a downstream location of test apparatus 10. Airflow “A” is operative to remove some if not all of the liquid residing on the articles, such as containers 50, after they are removed from the submerged state. After removal, such containers may be discharged and further transported by a transport assembly 110 of any convenient type known in the art with the structure of the same not being included within the scope of this invention.

With reference again to FIG. 4, a signal processor 120 is associated with imaging processor 70 and may be either independent of or formed as part of imaging processor 70. In any event, signal processor 120 is operative to generate a leak signal at 122 indicating the presence of an object in the field of view of at least a selected thresh hold size. This signal 122 may be presented to a system controller such that the system controller will produce a disable signal, at 124, that is presented to the conveyor drive 41 whereby to disable or stop advancement of the advance portion 46 of the conveyor and/or generate an alarm indicating detection of a faulty container. Thus, an operator, upon being alarmed of the faulty container, may approach and open a door 102 to retrieve the faulty container from the observation region 18.

With continued reference to FIG. 4, if desired, a temperature sensor 132 may be provided so that system controller 130 may monitor the temperature of the liquid bath. System controller 130 can operate a heating element 134, again of any desired type, so that the temperature of liquid bath 16 may be controlled. For example, it may desirable to heat the liquid bath 16 to an elevated state so that volatile compounds in a container cause internal pressurization of the container in order to enhance the leak detection.

Turning to FIG. 8, an alternate embodiment of the present invention is illustrated and is similar to that described with respect to FIGS. 1-7. Here, however, housing 172 contains two imaging processors including imaging processor 70 and imaging processor 170 respectively having view lines “X” and “Y” that are oriented at an acute angle “a” with respect to one another. Support assembly 184 is similar to support assembly 84 and acts as support imaging processor 170. Transparent panel 174 is enlarged, so that each of imaging processor 70 and 170 have an adequate field of view of containers 50 passing through observation region 18. By having two processors 70 and 170, a backup to detect a leak should one imaging processor fail. More importantly, the two imaging processors, when oriented at different view angle to the observation region, a stereoscopic view is possible. This provides better resolution for isolating where a leak is coming from, i.e., the faulty container. This information can potentially be used with automated removal equipment for removing the faulty container without an operator's intervention.

From the foregoing, it should be appreciated that a method of detecting a leak in an article is provided by the present invention. This method can include any of the processing steps inherent in the above-described apparatus and assemblies. Broadly, though, the method according to the present invention comprises a first step of providing a liquid bath having an upper liquid surface. Next, an article to be observed is placed at an observation region wherein the article is submerged beneath the upper surface of the liquid bath. The method includes the step of illuminating the observation region and monitoring the observation region by means of at least one imaging processor in order to detect bubbles of a thresh hold size emanating from a faulty article. Finally, the method includes the step of generating a control signal in response to the presence of a bubble having a size equal to or greater than the thresh hold size.

In greater detail, the method according to the embodiment of the present invention contemplates that the step of placing the article at the observation region is accomplished by dynamically advancing the article past the observation region. The step of advancing the article past the observation region can further be accomplished by supporting the article on an endless conveyor belt. Further, this conveyor belt may have an upstream terminus and a downstream terminus each located exteriorly of the liquid bath, and the method may include the step of magnetically retaining the article on the conveyor belt while the article is submerged.

If desired, the method according to the present invention may also include the step of heating the liquid bath thereby either to pressurize the article or to increase the pressure in an already pressurized article. The method may include the step of disabling the advancement of the article in response to the control signal. Moreover, the method contemplates that the threshold size of a bubble to be detected is selectively variable. The invention may include the step of blowing liquid off of the article at a downstream location after the article has exited the liquid bath, and the method may include the step of monitoring the observation region by means of at least two imaging processors in order to detect bubbles of the thresh hold size emanating from a faulty article.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. Apparatus adapted to detect leakage from a faulty article, comprising:
(A) a tank having an interior adapted to hold a liquid bath such that said liquid bath has an upper surface when the tank is in a filled state, said tank including an observation region;
(B) a conveyor assembly including an advance portion operative to move in a longitudinal direction from an upstream location above the upper surface of the liquid to a downstream location above the upper surface of the liquid through an intermediate location below the liquid surface at a depth such that an article supported thereon is submerged in a submerged state wherein it is beneath the upper surface of the liquid bath as it moves past the observation region when the tank is in the filled state;
(C) a drive operative to advance said advance portion from the upstream location to the downstream location;
(D) a light source operative to illuminate liquid located in the observation region when said tank is in the filled state; and
(E) at least one optical detector disposed at the observation region and operative to monitor a monitored volume of liquid in a view field that has a horizontal view width and a vertical view height and that has a transverse view depth of field along a view line that extends substantially across said tank in a direction that is transverse to the longitudinal direction and in the observation region, said optical detector operative to generate a leak signal indicating a presence of bubbles of a selected bubble size in the monitored volume of liquid caused by gas escaping from a faulty article.

2. Apparatus according to claim 1 wherein said tank is elongated and includes an elongated bottom wall, an upstream end wall, a downstream end wall and first and second elongated sidewalls in spaced-apart, opposed relation to one another and extending between said upstream and downstream end walls thereby to define the interior thereof, and including a substantially transparent panel in said first elongated sidewall located at said observation region.

3. Apparatus according to claim 2 wherein said observation station includes a background associated with the second sidewall in opposed relation to said transparent panel, said background including a light absorbing material.

4. Apparatus according to claim 3 wherein said background is a black background and is defined by a light absorbing panel removably supported relative to said second elongated sidewall.

5. Apparatus according to claim 4 including a pair of spaced-apart, opposed channel pieces mounted on said second elongated sidewall thereby to define a slideway, said light absorbing panel sized and adapted to be slideably received therein.

6. Apparatus according to claim 1 wherein the advance portion of said conveyor assembly has an article support side adapted to support articles thereon.

7. Apparatus according to claim 6 wherein said conveyor assembly includes an endless conveyor belt defining having the advance portion and having a return portion, said advance and return portions extending between an upstream conveyor terminus and a downstream conveyor terminus, said return portion being located exteriorly of said tank.

8. Apparatus according to claim 7 wherein said conveyor belt is constructed of stainless steel.

9. Apparatus according to claim 7 wherein said upstream terminus and said downstream terminus are each located exteriorly of said tank.

10. Apparatus according to claim 6 including a magnetic hold-down assembly disposed proximately to the advance portion of said conveyor on a side thereof that is opposite the support side, said magnetic hold down assembly operative to magnetically retain submerged ones of said articles on said advance portion.

11. Apparatus according to claim 10 wherein said magnetic hold-down assembly includes at least one elongated bar magnet extending longitudinally of said tank.

12. Apparatus according to claim 1 wherein said light source is supported above the observation region.

13. Apparatus according to claim 1 wherein the light source includes fluorescent lights.

14. Apparatus according to claim 1 wherein said optical detector is an imaging processor.

15. Apparatus according to claim 1 wherein said optical detector is adjustable whereby the selected bubble size to be detected is selectively adjustable.

16. Apparatus according to claim 1 including a light hood disposed proximately to the observation region and operative to mask at least some ambient light against entering the observation region.

17. Apparatus according to claim 16 wherein said light hood includes a housing extending longitudinally of and above said tank.

18. Apparatus according to claim 17 wherein said housing includes at least one door opening and a door movable between an open position allowing access to the advance portion of said conveyor assembly in the observation region and a closed position.

19. Apparatus according to claim 1 including a blow-off assembly disposed proximately to said conveyor assembly at a downstream location and operative to produce an air flow whereby at least some of the liquid residing on said articles after said articles are removed from the submerged state is removed by the air flow.

20. Apparatus according to claim 1 including electronic controls operative in response the leak signal to disable said conveyor assembly thereby to stop advancement of said advance portion and to generate an alarm indicating detection of a faulty article.

21. Apparatus according to claim 1 wherein the longitudinal width and the vertical height of the view field is selectably variable.

22. Apparatus according to claim 1 including at least two said optical detectors disposed at the observation station and operative to monitor the monitored volume of liquid, said optical detectors each having different transverse view lines and operative to generate a leak signal indicating a presence of bubbles of a selected bubble size in the monitored volume of liquid caused by gas escaping from a faulty article.

23. Apparatus adapted to detect leakage from a faulty container that is among an ensemble of containers having a selected container height, comprising:
(A) an elongated tank having an interior adapted to hold a liquid bath such that said liquid bath has a upper surface when the tank is in a filled state, said tank including an elongated bottom wall, an upstream end wall, a downstream end wall and first and second elongated sidewalls in spaced-apart, opposed relation to one another and extending between said upstream and downstream end walls, said tank including an observation station formed by a substantially transparent panel in said first elongated sidewall;
(B) a conveyor assembly including an endless conveyor belt having an advance portion and a return portion extending longitudinally between an upstream conveyor terminus and a downstream conveyor terminus, said advance portion having a container support side adapted to support containers thereon and operative to move in a longitudinal direction from an upstream location to a downstream location below the liquid surface at a depth that is greater than the container height when the tank is in the filled state whereby containers supported on the support side are submerged as they move past the observation region;
(C) a drive operative to advance said advance portion from the upstream location to the downstream location;
(D) a light source operative to illuminate liquid located in the observation region when said tank is in the filled state;
(E) an optical detector disposed at the observation station and having a view field that extends along a view line that is transverse to the longitudinal direction, said optical detector operative to generate a leak signal indicating a presence of bubbles of a selected bubble size in the liquid located in the observation region caused by gas escaping from a faulty container; and
(F) electronic controls operative in response the leak signal to disable said conveyor assembly thereby to stop advancement of said advance portion and to generate an alarm indicating detection of a faulty container.

24. Apparatus according to claim 23 wherein said observation station includes a background associated with the second elongated sidewall in opposed relation to said panel, said background including a light absorbing material.

25. Apparatus according to claim 24 wherein said background is black and is defined by a light absorbing panel removably supported relative to said second elongated sidewall.

26. Apparatus according to claim 25 including a pair of spaced-apart, opposed channel pieces mounted on said second sidewall thereby to define a slideway, said light absorbing panel sized and adapted to be slideably received therein.

27. Apparatus according to claim 23 wherein said return portion is located exteriorly of said tank.

28. Apparatus according to claim 27 wherein said upstream terminus and said downstream terminus are each located exteriorly of said tank.

29. Apparatus according to claim 23 including a magnetic hold-down assembly disposed proximately to the advance portion of said conveyor on a side thereof that is opposite the support side, said magnetic hold down assembly operative to magnetically retain submerged one of said containers on said advance portion.

30. Apparatus according to claim 29 wherein said magnetic hold-down assembly includes at least one elongated bar magnet extending longitudinally of said tank.

31. Apparatus according to claim 23 wherein said optical detector is an imaging processor.

32. Apparatus according to claim 23 including a light hood disposed proximately to the observation station and operative to mask at least some ambient light from against entering the observation region, said light hood including a housing extending longitudinally of and above said tank.

33. Apparatus according to claim 32 wherein said housing includes at least on door opening and a door movable between an open position allowing access to the advance portion of said conveyor assembly at a location associated with the observation region and a closed position.

34. Apparatus according to claim 23 including a blow-off assembly disposed proximately to said conveyor assembly at a downstream location and operative to produce an air flow whereby at least some liquid residing on said containers after said containers are removed from the submerged state is removed by the air flow.

35. A method of detecting a leak in an article, comprising:
(A) providing a liquid bath having an upper liquid surface;
(B) placing the article at an observation region wherein the article is submerged beneath the upper surface of said liquid bath;
(C) illuminating the observation region;
(D) monitoring the observation region by means of at least one imaging processor in order to detect bubbles of a threshold size emanating from a faulty article; and
(E) generating a control signal in response to the presence of a bubble having a size equal to or greater than the threshold size.

36. A method according to claim 35 wherein the step of placing the article at the observation region is accomplished by dynamically advancing the article past the observation region.

37. A method according to claim 36 wherein the step of advancing the article past the observation region is accomplished by supporting the article on an endless conveyor belt.

38. A method according to claim 37 wherein said conveyor belt has an upstream terminus and said downstream terminus each located exteriorly of the liquid bath.

39. A method according to claim 38 including the step of magnetically retaining the article on the conveyor belt while the article is submerged.

40. A method according to claim 35 including the step of heating the liquid bath thereby either to pressurize the article or to increase pressure in an already pressurized article.

41. A method according to claim 35 including the step of disabling the advancement of the article in response to the control signal.

42. A method according to claim 35 wherein the threshold size is selectively variable.

43. A method according to claim 39 including the step of blowing liquid off of the article at a downstream location after the article has exited the liquid bath.

44. A method according to claim 35 including the step of monitoring the observation region by means of at least two imaging processors in order to detect bubbles of the threshold size emanating from a faulty article.
